(19) United States
(12) Patent Application Publication
(10) Pub. No.: US 2007/0255647 A1
(43) Pub. Date: Nov. 1, 2007

(54) System, method and computer program product for evaluating and rating counterparty risk using experiential business process performance and financial data, and applications thereof

(75) Inventors: Jill Eicher, Glencoe, IL (US); David Ruder, Evanston, IL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Adattive Alpha, LLC, Chicago, IL (US)

(21) Appl. No.: 11/727,650

(22) Filed: Mar. 27, 2007

Related U.S. Application Data
(60) Provisional application No. 60/787,182, filed on Mar. 30, 2006.

(51) Int. Cl. G06Q 40/00

(52) U.S. Cl. 705/38

(57) ABSTRACT

A method, system and computer program product for evaluating and rating counterparty risk as it relates to counterparty financial strength and performance is disclosed. The evaluation of counterparty risk begins with the extraction of financial and experiential business process performance data that exists on the computer systems of investment businesses and their outsourced service providers. Financial data includes financial disclosures, reports and other statistical information, supporting the financial condition and ratings of a counterparty. Experiential business process performance data includes qualitative and quantitative information compiled from operating systems, databases, applications, workflows, electronic files and records that relate to: 1) the counterparties doing business with the investment business and 2) the investment business' operating infrastructure. A set of metrics and a series of algorithms are applied to the extracted data to measure and rate counterparty risk in terms of counterparty financial strength and counterparty experiential performance with an investment business. The evaluation and rating method includes: 1) measuring counterparty financial strength and experiential performance with an investment business; 2) analyzing and interpreting the risk identified by the data and measures; 3) putting the results into a contextual framework; and 4) computing an overall rating for counterparty risk.

### CROSS-REFERENCE TO RELATED APPLICATIONS

The present application claims the benefit of U.S. Provisional Patent Application No. 60/787,182 filed on Mar. 30, 2006, titled “System, Method And Computer Program Product For Evaluating Counterparty Risk Using Experiential Business Process And Financial Data, And Applications Thereof,” which is herein incorporated herein by reference in its entirety.

The present application is related to U.S. Pat. No. 7,136,827 titled “Method For Evaluating A Business Using Experiential Data,” and pending U.S. patent application Ser. No. 11/225,091, filed Sep. 14, 2005, titled “System, Method And Computer Program Product For Evaluating An Asset Management Business Using Experiential Data, And Applications Thereof,” both of which are herein incorporated by reference in their entireties. The present application is also related to “System, Method And Computer Program Product For Evaluating And Rating An Asset Management Business And Associated Investment Funds Using Experiential Business Process And Performance Data, And Applications Thereof” filed on Mar. 27, 2007 (Attorney Docket No. 2420.0040001), which is herein incorporated by reference in its entirety.

### BACKGROUND OF THE INVENTION

1. Field of the Invention

The present invention is generally directed to rating counterparty risk.

2. Background Art

The default risk related to most businesses can be evaluated by examining the financial statements of the firm and understanding basic customer, supplier, and competitor dynamics. Counterparty businesses, however, are different from businesses in general because their default risk potential is tied not only to their financial strength but also to their ability to assume and mitigate risk in the course of buying and selling securities.

The investment industry has experienced significant growth in recent years, particularly in the derivatives markets. The International Swaps and Derivatives Association estimates that at the end of 2005, notional principal amount outstanding of interest rate derivatives is $213.2 trillion; credit default swaps $17.1 trillion and equity derivatives $5.6 trillion. The unprecedented increase in volume in these markets, coupled with a spate of recent disturbances, has created an environment of uncertainty relating to the risk associated with counterparties involved in these transactions.

The Counterparty Risk Management Policy Group II issued its second report in 2005 (which followed its 1999 report which was precipitated by the Long Term Capital collapse involving 14 of the dominant industry counterparties) to address continued industry concern about counterparty risk and to make recommendations.

Many are concerned that the complexities of buying and selling some of the new and highly popular security instruments have put too much strain on the operational infrastructures of counterparties as well as other industry constituencies. This strain compromises the counterparties' ability, as well as other industry constituencies, to effectively process and settle these types of transactions, exposing global financial markets to disruption. This introduces the potential for default risk by counterparties for non-financial reasons.

While there is a desire to broaden the evaluation of counterparties to include an evaluation of counterparty risk, it has been problematic due to the shortcomings and limitations of conventional approaches. As a result, investors and asset managers have limited information to rely upon when choosing a counterparty or in assessing counterparty risk.

Accordingly, improved approaches for evaluating and rating counterparty risk are desired.

### BRIEF SUMMARY OF THE INVENTION

The present invention is directed to systems, methods and computer program products for evaluating and rating counterparty risk. As is well known, a “counterparty” is the other participant, including intermediaries, in a swap or contract. “Counterparty risk” is defined as the risk that the other party in an agreement will default.

As noted above, many are concerned that the complexities of buying and selling some of the new and highly popular security instruments have put too much strain on the operational infrastructures of counterparties as well as other industry constituencies. This strain compromises the counterparties' ability, as well as other industry constituencies, to effectively process and settle these types of transactions, exposing global financial markets to disruption. Counterparties are now being evaluated and rated without consideration of the risk related to default for non-financial reasons.

While there is a desire to broaden the evaluation of counterparties, it has been problematic due to the shortcomings and limitations of conventional approaches. As a result, investors and asset managers have limited information to rely upon when choosing counterparties.

As a result, various constituencies are interested in rating counterparty risk including: 1) insurance firms underwriting D&O and E&O policies for counterparties, 2) credit providers extending financial leverage to counterparties, and 3) investors and asset managers employing counterparties. The objective in rating counterparty risk is to facilitate decisions about whether and how to: 1) insure a counterparty; 2) loan capital to a counterparty and/or 3) employ a counterparty.

To evaluate counterparty risk, prior art methods generally use standard financial statement information. Typically, standard financial statement information covers one point in time, typically quarterly, and then is compared to prior periods. An analysis of financial statement information is generally the most widely practiced approach in evaluating the risk of counterparties.

There are three major shortcomings with the reliance on financial statement information in current evaluation and rating practices.

First, the financial condition of a counterparty is constantly changing as a result of the financial obligations a counterparty commits to on any given day due to investment opportunity. Given the quarterly practice of financial statement reporting for counterparties, the financial information available to investors or asset managers does not often reflect the continuous change in financial condition, nor the present financial condition of a counterparty. The lack of accurate and timely financial information creates exposure for investors and asset managers with respect to understanding counterparty risk. The present invention includes embodiments that reduce investor reliance on static financial information by providing information related to the risk of counterparty default.

Second, standard financial statements do not take into account the financial risk associated with counterparty default, either default due to financial issues or default for non-financial reasons. This is best illustrated by the concern of regulators like the Federal Reserve Bank regarding the ability of counterparty infrastructures to accommodate the volume and complexities as a result of the backlog of unsettled transactions such as the credit default swap backlog. Increasingly, counterparty risk has as much to do with operational effectiveness and reliability as it does with financial strength. The present invention includes embodiments that evaluate counterparty risk in terms of financial strength and operational performance.

A third major shortcoming with the current approach to rating counterparties is the evaluation of the counterparty without any consideration of the infrastructure and operations supporting the business. Evaluation of counterparties is primarily focused on periodic financial statements and neglects the fact that operational and infrastructure issues have and can negatively impact the ability of the counterparty to fulfill its contractual obligations. The present invention includes embodiments that include an evaluation of performance in evaluating and rating a counterparty and more specifically, evaluating and rating counterparty risk thereby providing investors and asset managers with a more comprehensive evaluation and rating than those that rely on periodic financial statement analysis.

In the investment industry, the data, information and systems available to manage investment portfolios are highly sophisticated, however, there is little in the way of data, information or systems to manage investment businesses. Prior art methods use financial data and analysis thereof as the measure of how well an investment business is performing and make little attempt to access or incorporate operating performance data in their evaluation. This results in a lack of understanding about the business supporting the investment activity and, therefore, the soundness of the counterparty.

Lacking data, information and systems, the various constituencies of the investment industry operate with an limited view and do not have the means to understand the interdependencies between financial strength and operating performance. In addition, they do not have a quantitative framework to evaluate counterparty risk.

Counterparty risk is best measured and understood in terms of counterparty financial strength as well as effectiveness and reliability in buying and selling securities. Understanding counterparty operational performance enables the understanding of a counterparty risk. This is important for investors and asset managers that employ counterparties in the context of performing their fiduciary responsibilities. Prior art approaches do not operate in this manner.

Many constituencies seek data to understand counterparty risk. These include investors and asset managers that rely on counterparties to fulfill contractual obligations relating to buying and selling securities; auditors that seek data on which to base management opinions; and credit providers, that seek to understand the potential risks of default, among others.

Accordingly, the present invention provides a system, method and computer program product for rating counterparty risk, such as but not limited to investment banks, broker dealers, asset managers, such as a mutual fund or hedge fund, by combining counterparty financial information with experiential performance information that exists on the computer systems of the client employing the counterparty and/or their outsourced service providers to evaluate counterparty risk.

Experiential performance information is produced in the course of buying and selling securities. Experiential performance information includes qualitative and quantitative information compiled or derived from operating systems, databases, applications, network infrastructure, electronic files and records that relate to the counterparty's performance.

The method includes: 1) the identification and application of previously untapped data from disparate computerized systems supporting investment businesses; 2) the automated extraction of financial and experiential performance data for the evaluation of counterparty risk; 3) the application of a set of metrics and algorithms to the extracted financial and experiential performance data to measure, analyze, interpret and ultimately rate counterparty risk; and 4) the utilization of both financial and experiential performance data in rating counterparty risk.

According to an embodiment, a specific set of mathematical functions, referred to as metrics and algorithms, are applied to the collected financial and experiential performance data to measure, analyze and interpret counterparty risk. The measures, scores and ratings are expressed as values or graded categories and provide a quantitative framework for understanding counterparty risk.

An embodiment of the invention provides two dimensions of analysis and perspective, one related to the financial strength of a counterparty and the other related to the performance of the counterparty. In this way, the present invention provides an understanding of the interdependency of financial strength and performance as it relates counterparty risk.

In the embodiments of the invention, the functions described herein are performed automatically using one or more computers. In other embodiments, some manual intervention is involved in some of the functions described herein. Implementation of these embodiments via software and hardware will be apparent to persons skilled in the art based on teachings contained herein.

These and other advantages and features will become readily apparent in view of the following detailed description of the invention. Note that the Summary and Abstract sections may set forth one or more, but not all exemplary embodiments of the present invention as contemplated by the inventor.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a system for evaluating and rating counterparty risk according to an embodiment of the invention.

FIG. 2 illustrates operational components of a counterparty risk rating system according to an embodiment of the invention.

FIG. 3 is a flow chart illustrating a process for evaluating and rating counterparty risk, according to an embodiment of the invention.

FIGS. 4A-4F are data flow diagrams illustrating the operation of an example embodiment of the invention for evaluating and rating counterparty risk.

FIG. 5A is an example computer system used to implement embodiments of the invention.

FIG. 5B is an example verification algorithm according to an embodiment of the invention.

FIG. 5C is a block diagram of an example interpretive algorithm system according to an embodiment of the invention.

FIG. 6 illustrates another functional view of a counterparty risk rating system according to embodiments of the invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION OF THE INVENTION

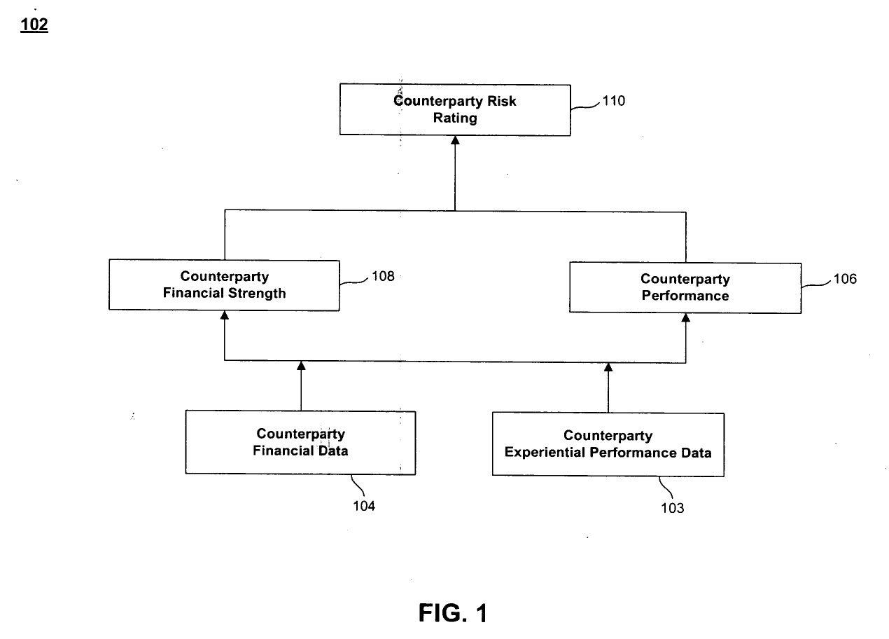

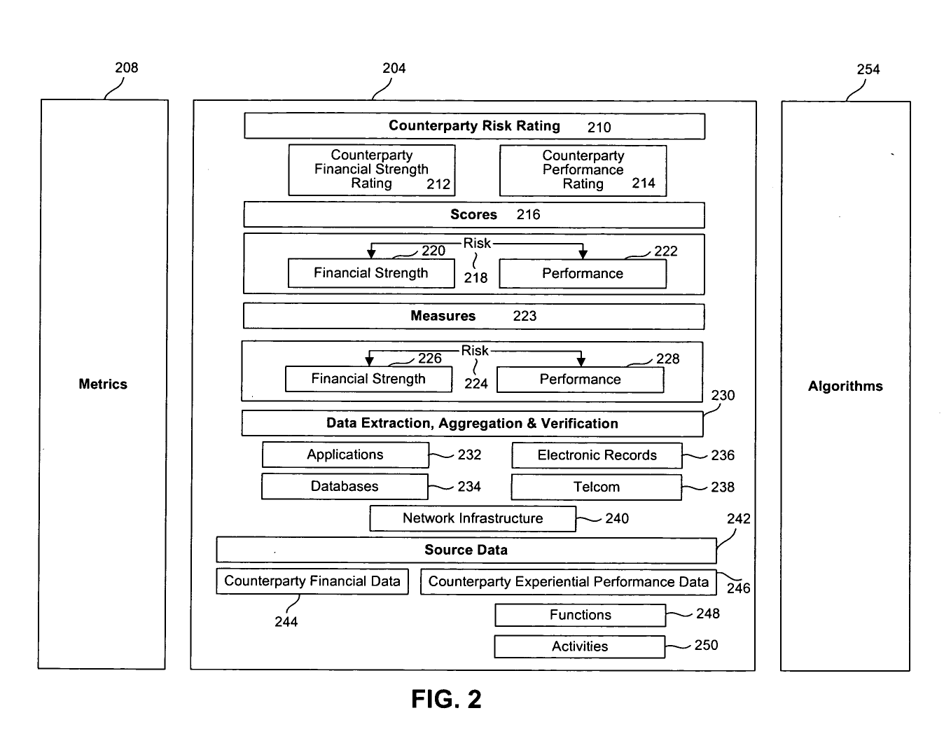

The present invention provides a system, method and computer program product for rating counterparty risk by measuring, analyzing and interpreting the risk associated with counterparty financial strength and experiential performance (i.e., how effective and reliable the counterparty is at buying and selling securities). To do so, the method uses standard financial data and experiential performance data generated in the course of buying and selling securities to fuel specific, predetermined mathematical functions, or metrics and algorithms, to rate counterparty risk. FIG. 1 illustrates a counterparty risk rating system 102 according to an embodiment of the invention. The counterparty risk rating system 102 generally operates as follows. Counterparty financial data 104 and experiential performance data 103 are used to assess the risk associated with counterparty financial strength 108 and counterparty performance 106, which are used in turn to determine a counterparty risk rating 110. FIG. 2 is a block diagram representing the operation of a counterparty risk rating system 102 according to an embodiment of the present invention.

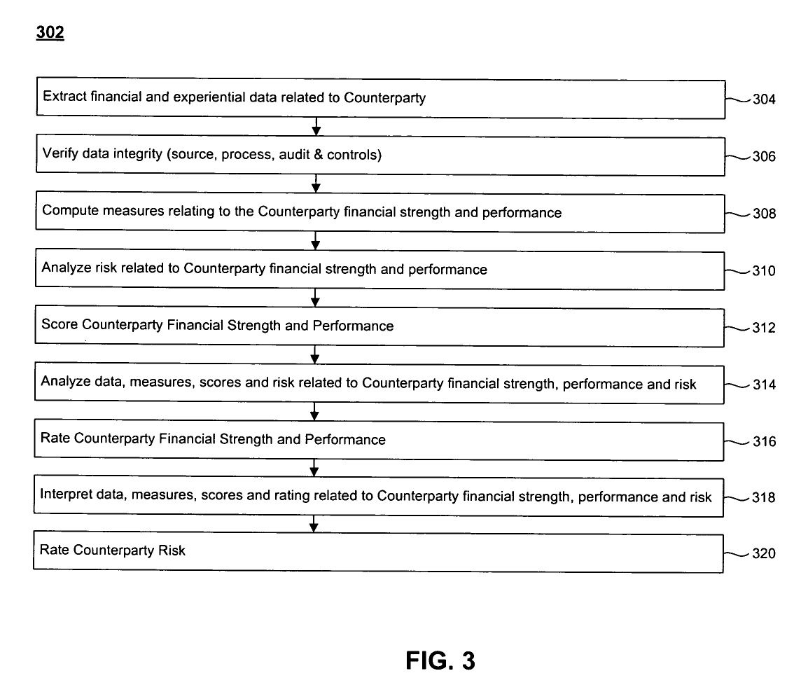

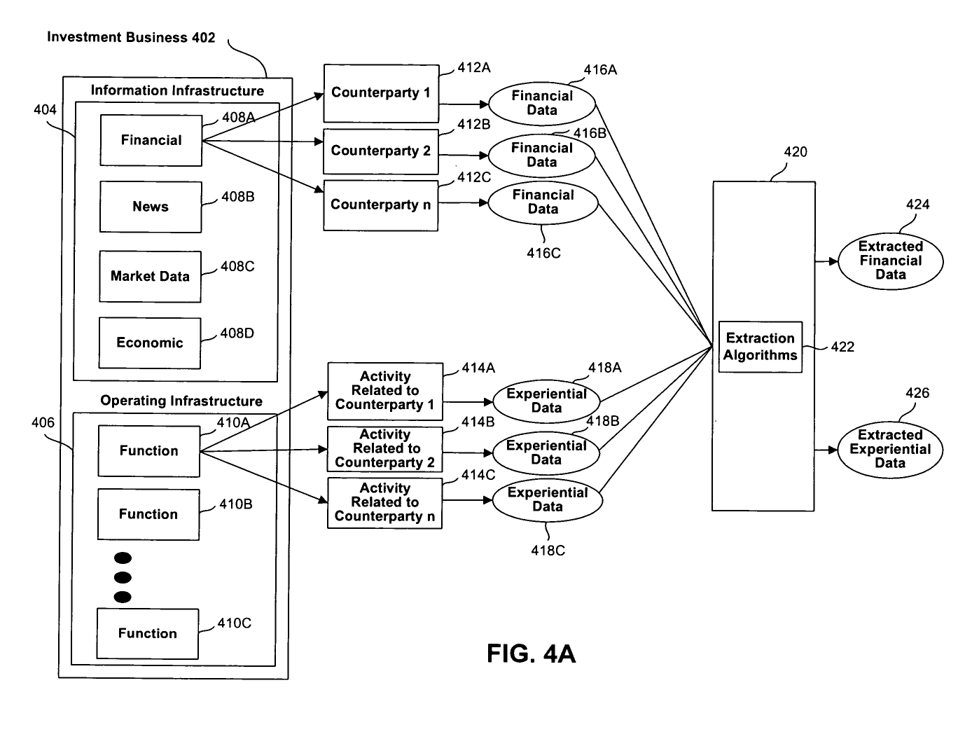

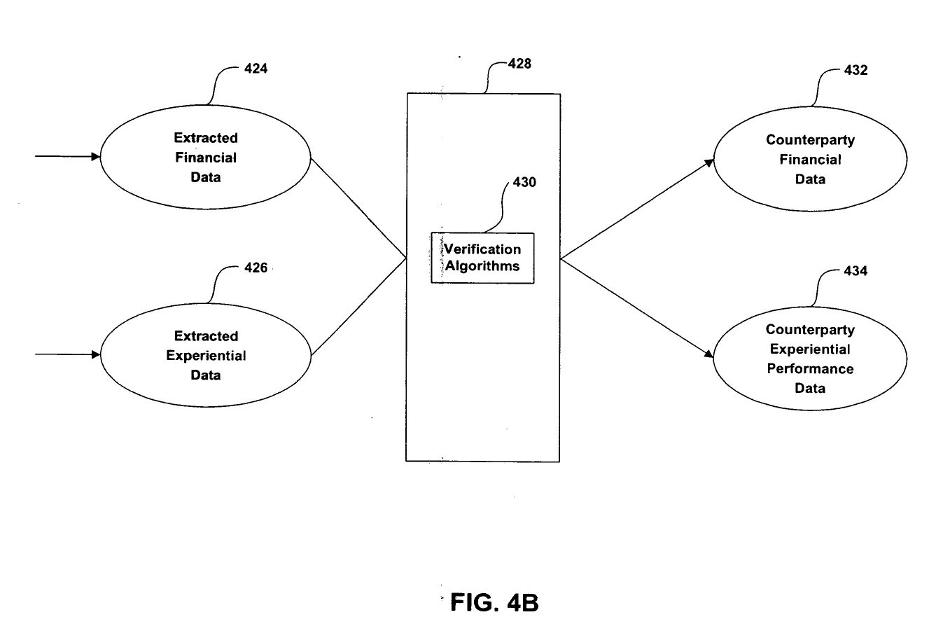

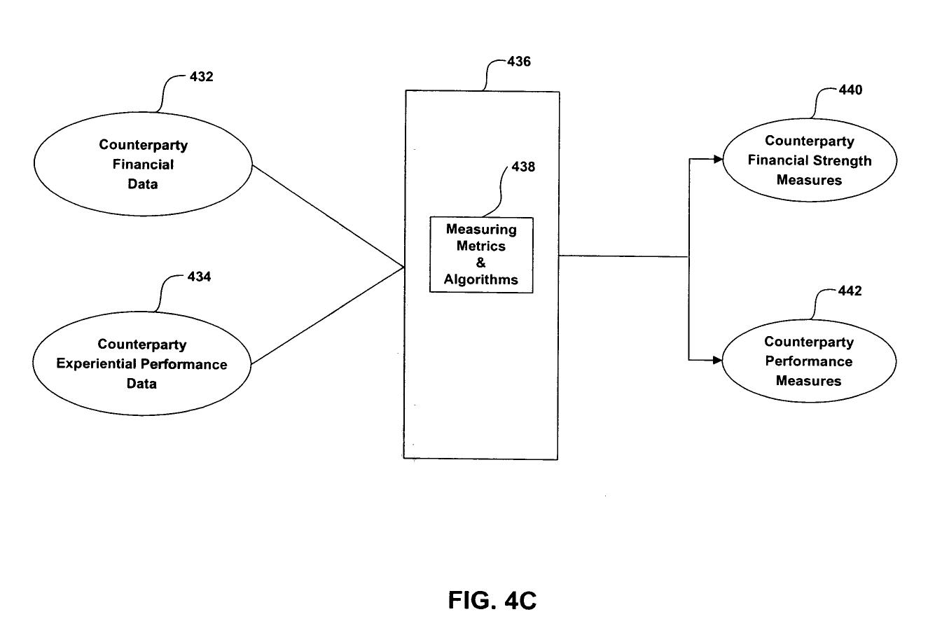

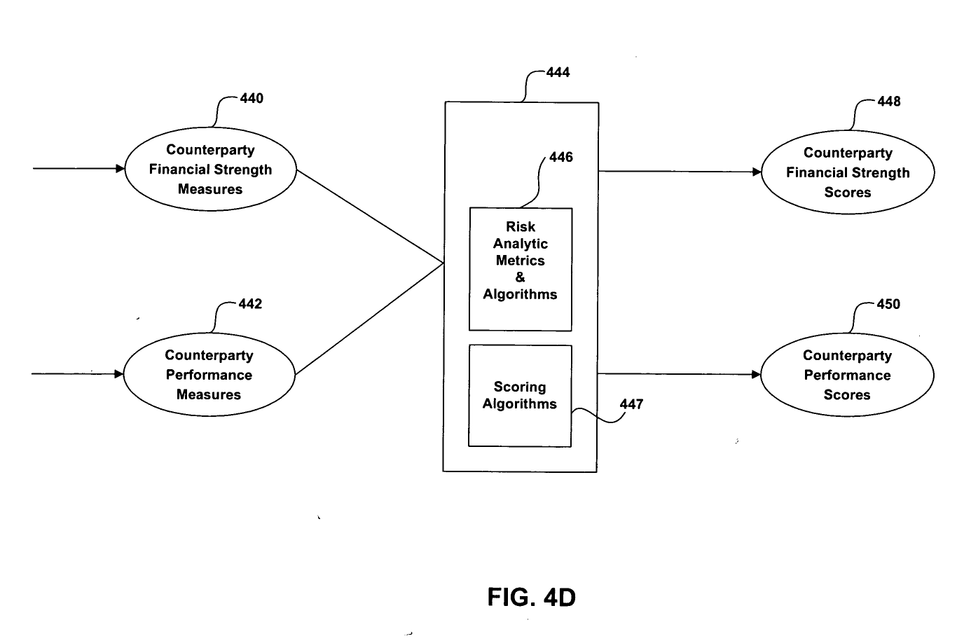

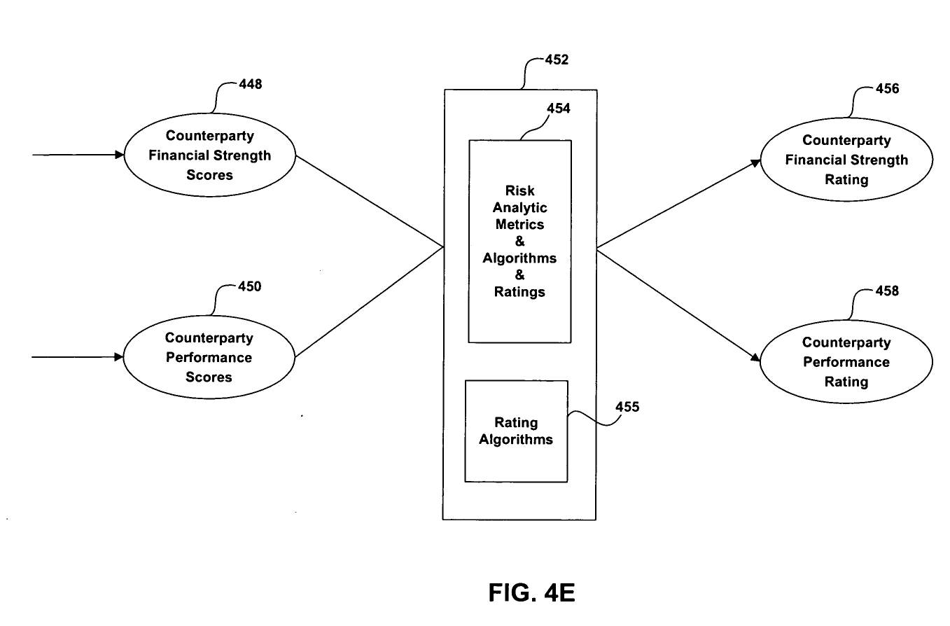

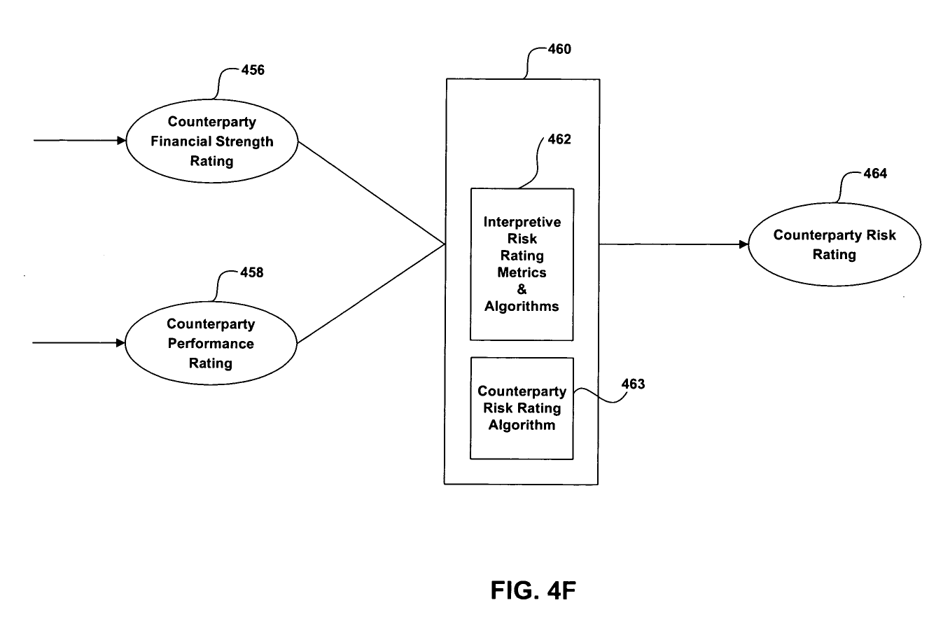

FIG. 3 illustrates a flowchart 302 of the steps of the inventive method for using publicly available counterparty financial data and experiential performance data generated in the course of buying and selling securities to fuel specific, predetermined mathematical functions, or metrics and algorithms, to evaluate and rate counterparty risk according to an embodiment of the invention. The first step is extracting data (step 304). Investment businesses can obtain standard counterparty financial data from many external sources or from the counterparty directly. This data is then often stored by the investment business for reference and analysis related to counterparties. Experiential performance data is generated in the course of buying and selling securities. The processing related to buying and selling of securities is achieved by performing business processes designed to carry out the requisite functions and activities related to buying and selling securities. Businesses are often thought of in terms of departments, however, the inventive method organizes an investment business by function and activity for greater specificity. Within each function is a sub-set of activities that make up the function. This is illustrated in the example data flow diagram of FIGS. 4A-4F. In particular, FIG. 4A illustrates an example business 402. The business 402 is organized according to the information infrastructure 404 and the operating infrastructure 406. The operating infrastructure 406 is further organized by the functions 410 it performs. Examples of these functions 410 are specified, for example, in Table 1. Each function 410 includes a number of activities 414. An exemplary set of functions 410 and their associated activities 414 are listed in Table 1. These example functions and activities are provided solely for purposes of illustration, and are not limiting.

TABLE 1
Business Organization by Function and Activity

| Function 408, 410 | Activity 412, 414 |
|---|---|
| Research | Idea generation |
| | Implementation strategy |
| Portfolio Management | Investment due diligence |
| | Strategy & execution |
| | Investment risk management |
| Sales | Market research |
| | New business |
| | Prospect development |
| Client Service | Communications |
| | Retention |
| Management/General | Alpha generation |
| Partner | |
| | Business strategy & execution |
| | Compensation |
| | Governance & ownership |
| Treasury | Cash management |
| | Human resources |
| | Margin financing |
| | Securities lending |
| Compliance | Business risk management |
| | External compliance |
| | Internal oversight |
| Controller | Audit/tax |
| | Corporate finance |
| | Portfolio accounting & reconciliation |
| | Pricing |
| Operations | Corporate actions |
| | Portfolio recordkeeping |
| | Proxy voting |
| | Trade capture |
| | Trade error resolution |
| | Trade settlement |
| Information Technology | Business continuity |
| | Data management |
| | Security |
| | System administration |
| | System development |
| | Web services |

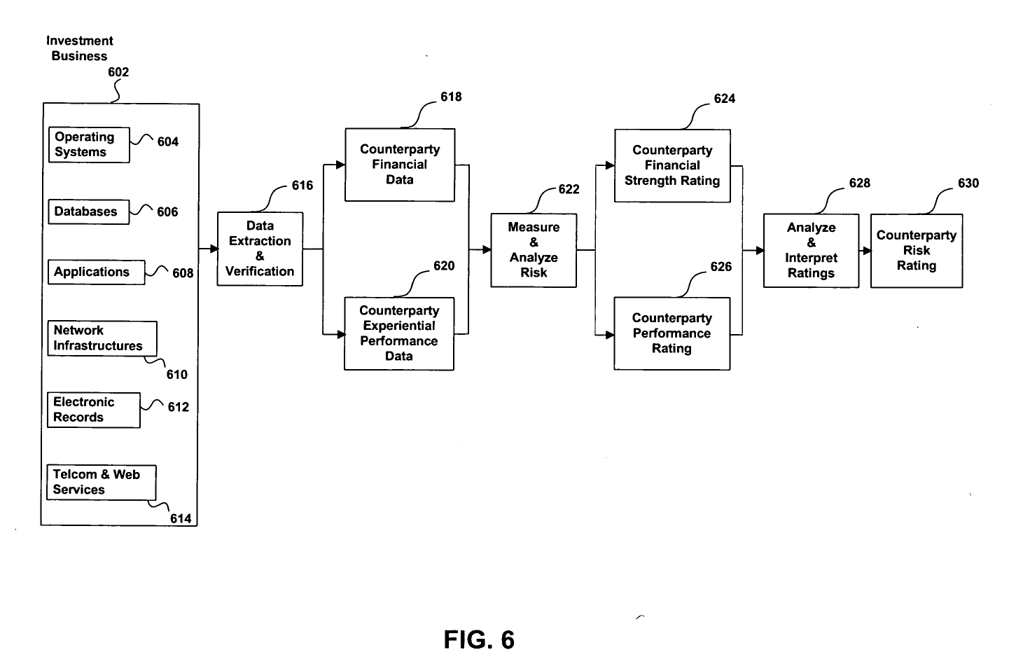

Financial and experiential performance data is extracted from databases and applications in addition to operating systems, databases, applications, network infrastructure, audit logs, electronic files and records supporting the investment business. FIG. 6 illustrates example computer systems used in investment businesses 602. FIG. 6 also illustrates the sequence of steps in an embodiment of the inventive method. The operation of these steps will be apparent to persons skilled in the relevant arts based on the teachings contained herein. The most common data available from investment businesses 602 comes from databases 606 and applications 608, however, the data used in the inventive method is not limited to data emanating from databases and applications. Data can be compiled from additional sources such as operating systems 604, network infrastructure 610, web services 614, audit logs, electronic communications, files and records 612 as well as supplied manually. An exemplary set of applications and databases supporting an investment business is listed in Table 2. The inventive method applies a set of metrics and algorithms to the data to produce measures of counterparty financial strength and performance effectiveness and reliability. The example of Table 2 is provided solely for purposes of illustration, and is not limiting.

TABLE 2
Asset Management Business Applications and Database Type

| Applications | Database Types |
|---|---|
| Transaction Processing | Transaction |
| Systems | |
| Analytic | Holdings |
| Portfolio management | Performance |
| Order management | Reference data |
| Trading | Policies & procedures |
| Risk management | Human resource |
| Compliance | Customer relationship |
| Trade allocation, notification | Proprietary or implementation dependent |
| & delivery | |
| Reconciliation | Proprietary or implementation dependent |
| General ledger | Proprietary or implementation dependent |
| Trade capture | Proprietary or implementation dependent |
| Portfolio accounting | Proprietary or implementation dependent |
| Market data, news & utilities | Proprietary or implementation dependent |
| Performance measurement & | Proprietary or implementation dependent |
| attribution | |
| Proxy voting | Proprietary or implementation dependent |
| Corporate action processing | Proprietary or implementation dependent |
| Proprietary or other | Proprietary or implementation dependent |
| applications | |

FIG. 2 broadly illustrates the operation of a counterparty risk rating system according to an embodiment of the invention, working from the bottom of the middle column of the diagram to the top. The column on the left represents the metrics 208 which are applied to the extracted financial and experiential performance data to measure the financial strength and performance of the counterparty. These inventive measures 208 may be expressed as values or graded categories. The column to the right represents the algorithms 254 which analyze and interpret the risk associated with the measures 208 to rate counterparty financial strength and performance and to compute an overall risk rating for the counterparty. The example operation depicted in FIG. 2 shall now be described in greater detail with reference to the operational flowchart 302 of FIG. 3 and the example data flow diagrams of FIGS. 4A-4F.

As previously mentioned, the first step is to extract source data consisting of counterparty financial data 424 and counterparty experiential performance data 426 (this is performed in step 304 of FIG. 3). Examples of the functions and activities of an investment business generating the counterparty experiential performance data as well as the applications and databases systems primarily involved in handling and storing the counterparty financial experiential performance data of an investment business are listed in Tables 1 and 2, above.

Referring to the example of FIG. 4A, counterparty financial data is obtained by investment businesses and stored and maintained in their information infrastructures 404. Counterparty experiential performance data 426 is generated when the investment business and the counterparty buy and sell securities. To do so, business processes related to the functions 408 and associated activities 412 are performed. Counterparty financial data 416 would include, but not be limited to, financial statements and third part rating information such as that provided by (but not limited to) Standard and Poors, Moody's and Lehman Brothers for example. Counterparty experiential performance data 418 would include, but not be limited to, transactional data related to buying and selling securities as well as data about the data, for example, source verification data related to transactional information supplied by the counterparty. Such counterparty financial and experiential performance data is collected in this first step 304. An example of data about the data would be the time and data stamp data assigned by the computer in the course of performing a business process. For example, when buying a security, an order management system time and data stamps the order to buy at various points in time, for example, when the order is first introduced to the system, when it is executed and when the order is allocated. This data that is created in the course of performing the business processes fueling the functions and activities of the business, and is an additional source of counterparty experiential performance data.

Examples of counterparty financial data and counterparty experiential performance data is detailed in Table 3. The example of Table 3 is provided solely for purposes of illustration, and is not limiting.

TABLE 3
Examples of Source Data

| Counterparty | Counterparty |
|---|---|
| Financial Data | Experiential Performance Data |
| Financial statements | Timeliness of trade confirmation |
| Ratings | Accuracy of data |
| 10 K, 10 Q | Reliability in settling trades |
| Annual reports | Efficiency in error resolution |
| Earnings reports | Frequency of cancelled trades |

Investment businesses often rely on agents to maintain the books and records of their business. In so doing, some of the business processes involved in the functions and activities of the business are executed by the agent on behalf of the investment business. As a result, counterparty experiential performance data resides on the operating systems, databases, applications, network infrastructure of the agent. An alternative embodiment of the present invention includes extracting the counterparty's experiential performance data from such an agent, for example, an investment bank (prime broker), custodian, fund administrator, or other service provider using the inventive method as described. An example extraction algorithm is shown as 422 in FIG. 4A.

In an embodiment, the extraction algorithm 422 is a set of pre-determined instructions designed for the extraction of specific data and executed by a computer program. These instructions include well-defined requests for each data set required. Data, such as, investment performance results would include such specifications as time period and name of portfolio results being requested. The instructions would also detail how the data request is made, where the request is directed and what constitutes finding and extracting it satisfactorily.

The next step is to verify the integrity of the data (step 306). Inventive verification metrics and algorithms 430 are applied to the extracted counterparty financial and experiential performance data 424, 426 to confirm its source and the integrity of the extraction process 422 by applying built-in logic, control checks and audit log verification.

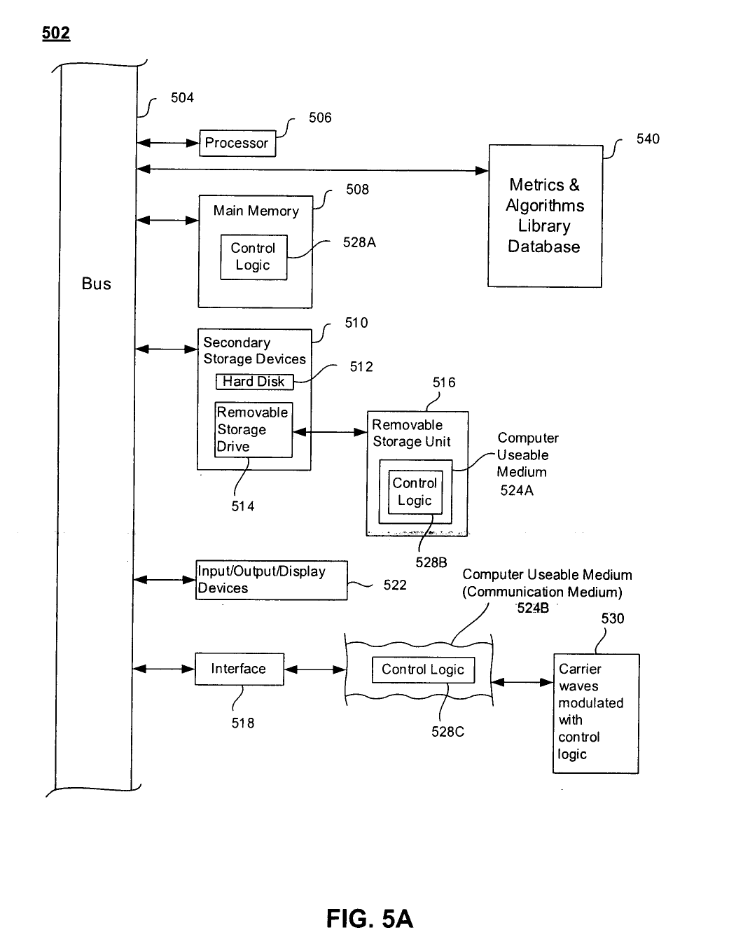

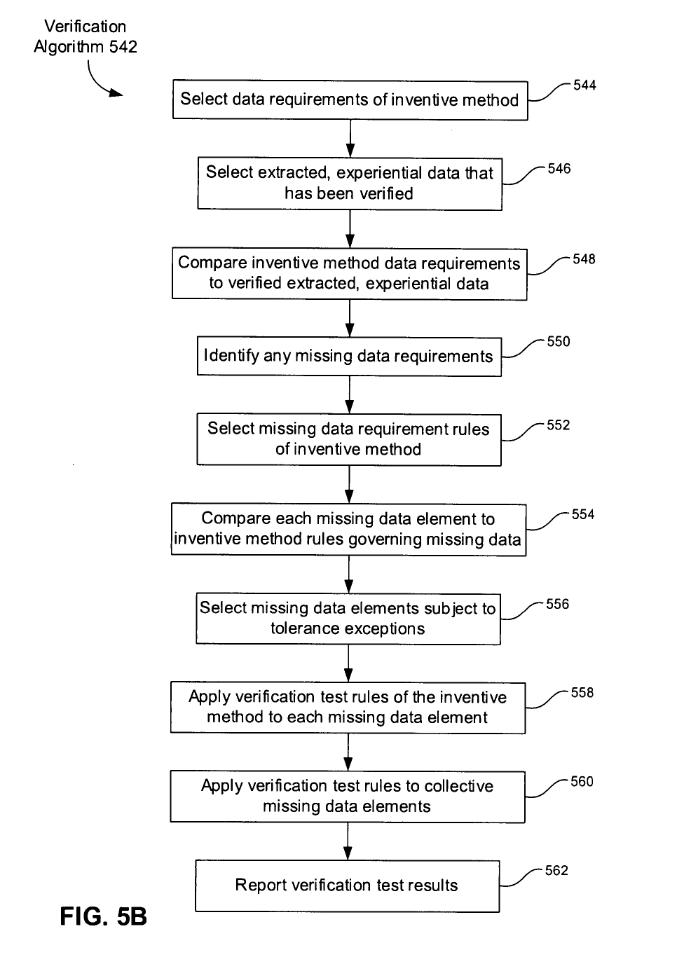

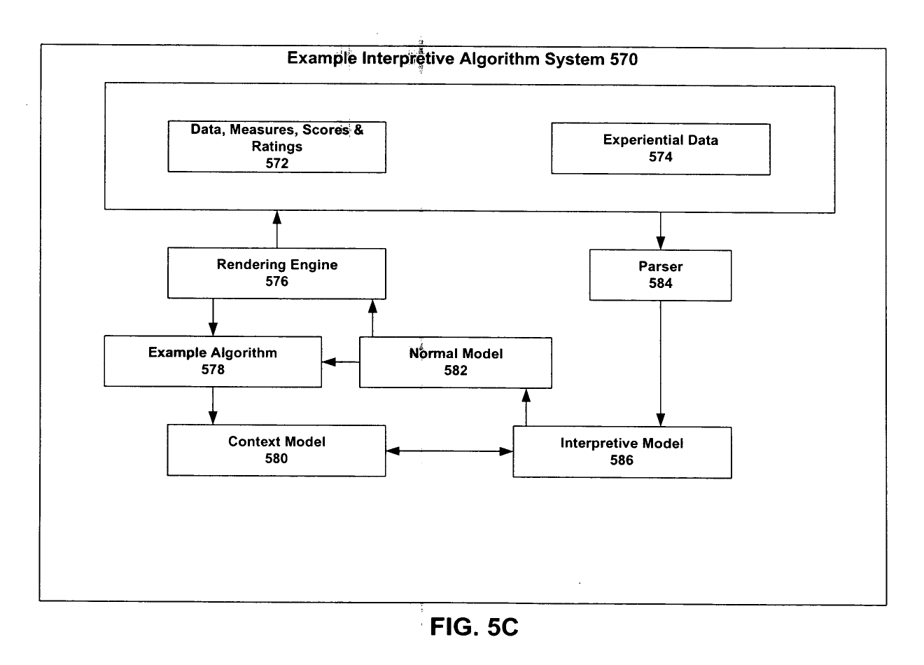

FIG. 5A is an example computer implementation of the inventive method. In FIG. 5A, an example database 540 of metrics and algorithms of the inventive method is shown. In step 306, a verification algorithm 430 is applied to the extracted data 424, 426 to determine, for example, whether all of the data required by the inventive method has been extracted. In an embodiment, to make this determination, the algorithm 430 compares the data extracted 424, 426 to the data requirements of the inventive method. The algorithm 430 identifies any missing data elements and then applies pre-set inventive rules pertaining to missing data, including tolerance guidelines. The algorithm 430 then applies an inventive verifications test to each missing data element to determine whether any individual missing data element would precipitate a failed verification test. If none of the missing data elements individually causes a failed verification test, then the inventive algorithm 430 applies an inventive, pre-determine verification test to the collective missing data elements.

An example verification algorithm 542 is illustrated in FIG. 5B, which shall now be described. In step 544, data requirements are selected (the requirements may be pre-selected, and/or input/revised by an operator). In step 546, extracted counterparty financial and experiential performance data 424, 426 are selected. In step 548, the data requirements are compared to the extracted, counterparty financial and experiential data 424, 426. In step 550, any missing data requirements are identified. In step 552, missing data requirement rules are selected. In step 554, each missing data element is compared to the selected rules governing missing data.

These rules define the actions to be taken when a requested data element has not been supplied. For example, if trade settlement data had been requested for three time periods but data only for two time periods was supplied, rules are applied to the condition when trade settlement data is not supplied for a time period requested. The rules dictate the sequence of activity to be taken under this condition. An example sequence of activities includes 1) requesting the data again; 2) sending an alert notification; and 3) logging the data request failure.

In step 556, missing data elements that are subject to tolerance exceptions are selected.

A tolerance exception occurs when a data request has been made and the data has been supplied in response to the request, yet there is a variance between the data requested and the data supplied. The variance results in an exception. Exceptions are subjected to tolerance tests to determine the magnitude of the variance and ultimately, whether the data request has been satisfied.

An example of a tolerance exception is illustrated by the condition of a request for data related to pricing on trade notifications requiring the supply of the price information to three decimal places yet data is supplied only to two decimal places. A tolerance test is applied to the exception to determine whether data to two decimal places is satisfactory or not.

In step 558, verification test rules are applied to each missing data element. In step 560, verification test rules are applied to collective missing data elements.

Verification rules apply to the integrity of the data. For example, its source and the methodology used in obtaining it. Verification rules determine, for example, whether the data was extracted directly from a designated source system or whether it was supplied by manual intervention.

In step 562, verification test results are reported.

The inventive method performs the verification process 430 to derive additional experiential infrastructure data 418 related to the counterparty being evaluated as discussed above. This step is illustrated in FIG. 4B An example of experiential data created in the verification process is the time, date and duration of the verification process. Such data provides a quantitative framework to identify and understand data integrity issues.

Data is easily compromised in the investment industry owing to lack of standard data models, communication protocols and widespread disparate systems and legacy technology issues. Data integrity is further pressured by the complexity of the source data, i.e., the security instruments and the transaction types involved. The inventive method is designed to glean information from the business processes of an investment business related to the integrity and security of its data.

The next step is to compute measures (step 308). In the example of FIG. 4C, measuring metrics and algorithms 438 are applied to the verified data 432, 434 to compute counterparty financial strength and counterparty performance measures 440, 442. These measures, or criteria, may be expressed as values or graded categories.

Measures 440, 442 are calculated to understand the financial strength of the counterparty and how effective and reliable the counterparty is in buying and selling securities. A pre-determined set of measures is applied to the verified financial and experiential performance data 432, 434 generated in the course of buying and selling securities. For example, trade capture is an activity of the operations functions as illustrated in Table 1. An exemplary measure of how well the trade capture activity is performing can be measured by computing the percent of trades captured on-time. Continuing the example of measuring trade capture performance, an exemplary measurement algorithm 438 is used to evaluate the trade capture activity overall. This measure involves compiling various measures and using simple math to combine them to produce a representative summary activity measure of performance, such as the percent of trades captured on-time, error-free, and electronically.

The next step is to analyze the measures (step 310) of counterparty financial strength and counterparty performance in terms of risk inferred by the measures. In the inventive method, the measures are weighted by their importance as a counterparty risk determinant by an inventive analytic algorithm 446. Weightings are determined by a set of metrics and algorithms 446 designed to account for the interdependencies of the determinants on financial strength and performance. In the example embodiment of FIG. 4D, this step is achieved by averaging and weighting the previously determined measures 440, 442.

Another embodiment of the invention is to utilize metrics and algorithms 446 to analyze the measures by establishing a baseline of counterparty risk, financial strength and performance for the counterparty being evaluated. Additional metrics and inventive algorithms (which may be part of or separate from metrics and algorithms 446) are applied to compute “normal” and “actual” measures. Normal measures relate to a baseline of risk, financial strength and performance for the counterparty being evaluated. A baseline is established by averaging a time series of measures to compute normal measures. Actual measures, the current period risk, financial strength and performance measures, are then compared to the baseline.

For example, settlement rate is a measure of counterparty performance. To continue the example, a counterparty has a 98% settlement rate with an investment business in the current period, i.e., an actual measure. This is compared to the counterparty's normal measure of 96% computed using a time series of the counterparty's settlement rate measures from prior periods. This example embodiment provides additional performance analytic measures to be used in the evaluation, scoring and rating of counterparty risk.

Furthermore, these measures described above are used to objectively, automatically and quantitatively assess the consistency of counterparty financial strength and performance. These measures are also used to assess counterparty risk by comparing actual and normal measures to then analyze the variances. This provides a baseline of risk, financial strength and performance for a counterparty using its own risk, financial strength and performance standards to be measured against.

The next step is to score counterparty financial strength and performance (step 312). The weighted measures generated by risk analytic metrics and algorithms 446 are combined to produce scores 448, 450 that quantitatively represent counterparty financial strength and performance. Scoring algorithms 447 take these weighted measures and first compare them to a baseline of corresponding measures previously derived in other time periods. Pre-determined credits are given for measures that have improved and pre-determined debits are given for measures that have underperformed. In this way, the inventive method provides a quantitative framework to easily identify and quantify risk and performance contributors or detractors.

The next step is to analyze the data, measures and scores (step 314). In the inventive method, an inventive algorithm 454 is used to assess the impact of current data 432, 434, measures 440, 442 and scores 448, 450 on counterparty risk, financial strength and performance. The inventive algorithm 454 is designed to factor the degree of impact of the changes in the data 432, 434, measures 440, 442, and scores 448, 450 on counterparty risk, financial strength and performance. The inventive algorithm 454 also draws from the weightings assigned in the previous step.

With respect to step 314, an embodiment of the invention is the interpretation of counterparty risk, financial strength and performance data, measures and scores against a changing context. The interpretive algorithms are designed to create and maintain models of the evolving risk levels of a counterparty. The data structures (i.e., context models) of the algorithms contain the data, measures and scores and their associated properties available for reference. In the data structures (context models) new data, measures and scores are compared to existing data, measures and scores.

For example, a data structure (context model) for data related to the trade settlement activity of the operations function includes the number of trades settled in the current period. An example interpretive algorithm compares the number of trades settled in the current period data structure to a normal period data structure comprised of the average number of trades settled in previous, similar time periods. The trade settlement data structure also includes other information that can be factored into the comparison process by the inventive algorithm, such as the degree of importance any change in settlement rate would have counterparty risk, financial strength and performance.

An example of a data structure (context model) for measures related to the trade settlement activity of the operations function includes the frequency of an on-time settlement rate in the current period. An example interpretive algorithm compares the frequency of an on-time settlement rate to, for example, changing trade volumes and security complexity to measure the impact of trading activity dynamics on counterparty risk, financial strength and performance.

An example of a data structure (context model) for a score related to the trade settlement activity of the operations function includes combining multiple factors, such as related counterparty performance scores that would allow a projection of the impact of current performance on counterparty risk. A mechanism for modeling the impact of current performance is another component of the example inventive algorithm.

Data structures (context models) are updated in the inventive method as a result of events such as data extraction or data verification. Multiple types of information are stored in data structures (context models) in order to facilitate comparison interaction and to provide local interpretive contexts for each event.

An interpretive algorithm 570 for performing the operation described above is illustrated in FIG. 5C. To illustrate, an exemplary interpretive algorithm related to trade settlement will be discussed in the context of FIG. 5C.

An embodiment of an exemplary interpretive algorithm related to trade settlement begins with experiential data 574 collected as described above, such as the number of trades settled in the current period, current trading volume, assets under management, number of each security type traded in current period and the number of each transaction type executed in the period. Experiential data 574 is then input into the parser 584 which transforms the trade settlement data into data structures designed to organize the hierarchy of the trade settlement data elements in relation to each other. The parsed information is then sent to the interpretive model 586 which puts the new trade settlement information into context for analysis. Information flows between the interpretive model 586 and the context model 580 to facilitate the interpretation of the trade settlement information. For example, the context model 580 models the effect of current trade settlement information on various performance interpretive parameters, such as the impact of declining trade settlement effectiveness on performance. Information also flows from the interpretive model 586 to the normal model 582. The normal model 582 structures historical (or baseline) trade settlement information. The inventive algorithm 570, for example, analyzes the trade settlement information to determine the persistence of the declining trade settlement effectiveness and the impact on performance. Information flows from the normal model into the rendering engine 576 which formats and displays the interpreted trade settlement information.

The next step is to rate counterparty financial strength and performance (step 316). An inventive algorithm 455 combines the data 432, 434, measures 440, 442 and scores 448, 450 related to counterparty financial strength and performance to quantitatively express the indicative level of counterparty financial strength and performance 456, 458.

One component of the inventive rating algorithm 455 involves the determination of directionality in the data, measures and scores of counterparty financial strength and performance. Data, measures and scores are sorted in chronological order to determine how these indicators of performance impact counterparty risk (i.e., favorably or not) both in the current time period perspective as well as how they might impact counterparty risk in future time periods should performance persist. A set of rules to infer the nature and severity of change in data, measures and scores involves comparing changes in the current period with the experiential impact of similar change dynamics conditions in prior periods. The degree of change in the data, measures and scores are measured and weighted for their specific and collective impact on the current and future counterparty risk. Pre-determined values are added or deducted from the weightings according to their importance and potential impact.

The next step is to interpret the counterparty financial strength and performance ratings (step 318). In this step, an inventive interpretive algorithm 462 expressly designed to interpret the counterparty financial strength and performance ratings 456, 458 is used to interpret the implications of changes on counterparty risk and to put the ratings into context.

For example, an inventive algorithm 462 interprets the counterparty financial strength and performance ratings in the context of other selected risk dynamics such as the impact of directionally decreasing performance in counterparty trade settlement performance as trading volume is directionally increasing and the frequency of complex security types is increasing. In this example, the modeling mechanism of the inventive algorithm 462 analyzes a pre-determined series of experiential and projected scenarios involving trade settlement operations, trading volume and security type complexity. The inventive algorithm 462 identifies key determinants in various experiential scenarios and quantitatively rates the determinants by their potential impact based on experiential data. The quantified determinants are then weighted by their importance and degree of interdependency and utilized by the inventive algorithm 462 to put the ratings into context both in relative and objective terms based on the experience of the investment business and the counterparty.

The next step is to rate counterparty risk (step 320). The method culminates in rating counterparty risk by factoring the counterparty financial strength and performance ratings 456, 458 together, the process of which involves using an inventive rating algorithm 463 designed to evaluate and quantify the level of counterparty risk using data 432, 434, measures 440, 442 scores 448, 450, ratings 456, 458 and additional algorithmic interpretive information derived in previous steps (steps 310, 314, and/or 318).

The inventive method relies on computers to execute a series of algorithms that incorporate previously calculated metrics and algorithmic analyses and interpretations. The inventive algorithm 463 identifies key determinants in various experiential scenarios and quantitatively rates the determinants by their potential impact based on experiential data. The quantified determinants are then weighted by their importance and degree of interdependency and utilized by the inventive algorithm 463 to combine and calculate the values assigned to the metrics, analyses and ratings in order to compute a risk rating for the counterparty.

For example, in a current measurement period, assume that all of the current measures, scores and interpretive analysis indicate that counterparty performance is comparable across all key determinants of baseline performance, however, two components of financial strength are below the baseline. An interpretive algorithm (which is part of algorithm 463) analyzes past results involving the two components of financial strength and finds that they are key determinants of counterparty risk and therefore weights them heavily in the calculation of the risk rating of the counterparty.

It is noted that, in the above description, references to “algorithm” or “algorithm” may correspond to software and/or hardware modules.

Example Computer Implementation

In an embodiment of the present invention, the system and components of the present invention described herein are implemented using well known computers, such as computer 502 shown in FIG. 5.

The computer 502 can be any commercially available and well known computer capable of performing the functions described herein, such as computers, as well as any other data processing device available from International Business Machines, Apple, Sun, HP, Dell, Compaq, Digital, Cray, etc.

The computer 502 includes one or more processors (also called central processing units, or CPUs), such as a processor 506. The processor 506 is connected to a communication bus 504.

The computer 502 also includes a main or primary memory 508, such as random access memory (RAM). The primary memory 508 has stored therein control logic 528A (computer software), and data.

The computer 502 also includes one or more secondary storage devices 510. The secondary storage devices 510 include, for example, a hard disk drive 512 and/or a removable storage device or drive 514, as well as other types of storage devices, such as memory cards and memory sticks. The removable storage drive 514 represents a floppy disk drive, a magnetic tape drive, a compact disk drive, an optical storage device, tape backup, etc.

The removable storage drive 514 interacts with a removable storage unit 516. The removable storage unit 516 includes a computer useable or readable storage medium 524 having stored therein computer software 528B (control logic) and/or data. Removable storage unit 516 represents a floppy disk, magnetic tape, compact disk, DVD, optical storage disk, or any other computer data storage device. The removable storage drive 514 reads from and/or writes to the removable storage unit 516 in a well known manner.

The computer 502 also includes input/output/display devices 522, such as monitors, keyboards, pointing devices, etc.

The computer 502 further includes a communication or network interface 518. The network interface 518 enables the computer 502 to communicate with remote devices. For example, the network interface 518 allows the computer 502 to communicate over communication networks or mediums 524B (representing a form of a computer useable or readable medium), such as LANs, WANs, the Internet, etc. The network interface 518 may interface with remote sites or networks via wired or wireless connections.

Control logic 528C may be transmitted to and from the computer 502 via the communication medium 524B. More particularly, the computer 502 may receive and transmit carrier waves (electromagnetic signals) modulated with control logic 530 via the communication medium 524B.

Any apparatus or manufacture comprising a computer useable or readable medium having control logic (software) stored therein is referred to herein as a computer program product or program storage device. This includes, but is not limited to, the computer 502, the main memory 508, the secondary storage devices 510, the removable storage unit 516 and the carrier waves modulated with control logic 530. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for rating counterparty risk, comprising:
extracting financial and experiential data relating to counterparty;
verifying data integrity;
computing measures relating to counterparty financial strength and performance;
analyzing risk related to counterparty financial strength and performance;
scoring counterparty financial strength and performance;
analyzing data, measures, scores and risk related to counterparty financial strength, performance and risk;
rating counterparty financial strength and performance;
interpreting data, measures, scores and ratings related to counterparty financial strength, performance and risk; and
rating counterparty risk.
